(19) United States
(12) Patent Application Publication
(10) Pub. No.: US 2016/0339385 A1
(43) Pub. Date: Nov. 24, 2016

(54) SORBENTS FOR REMOVAL OF MERCURY

(71) Applicant: Calgon Carbon Corporation, Moon Township, PA (US)

(72) Inventors: Richard A. MIMNA, Oakdale, PA (US); Walter G. TRAMPOSCH, Moon Township, PA (US)

(21) Appl. No.: 15/160,605

(22) Filed: May 20, 2016

Related U.S. Application Data
(60) Provisional application No. 62/164,105, filed on May 20, 2015.

(51) Int. Cl. B01D 53/64; B01D 53/83

(52) U.S. Cl. CPC B01D 53/64; B01D 53/83; B01D 2253/102; B01D 2251/108; B01D 2257/602

(57) ABSTRACT

Methods and systems for reducing mercury emissions from fluid streams are provided herein, as are adsorbent materials having high volumetric iodine numbers.

### CROSS-REFERENCE TO RELATED APPLICATIONS

This application claims priority from U.S. Provisional No. 62/164,105 entitled “Sorbents for Removal of Mercury,” filed May 20, 2015, the contents of which are hereby incorporated by reference in their entirety.

### GOVERNMENT INTERESTS

Not Applicable

### PARTIES TO A JOINT RESEARCH AGREEMENT

Not Applicable

### INCORPORATION BY REFERENCE OF MATERIAL SUBMITTED ON A COMPACT DISC

Not Applicable

### BACKGROUND

Mercury is a known environmental hazard and leads to health problems for both humans and non-human animal species. Approximately 50 tons of mercury per year are released into the atmosphere in the United States, and a significant fraction of the release comes from emissions from coal burning facilities such as electric utilities. To safeguard the health of the public and to protect the environment, the utility industry is continuing to develop, test, and implement systems to reduce the level of mercury emissions from its plants. In the combustion of carbonaceous materials, it is desirable to have a process wherein mercury and other undesirable compounds are captured and retained after the combustion phase so that they are not released into the atmosphere.

One of the most promising solutions for mercury removal from flue gas is Activated Carbon Injection (ACI). Activated carbon is a highly porous, non-toxic, readily available material that has a high affinity for mercury vapor. This technology is already established for use with municipal incinerators. Although the ACI technology is effective for mercury removal, the short contact time between the activated carbon and the flue gas stream results in an inefficient use of the full adsorption capacity of the activated carbon. Mercury is adsorbed while the carbon is conveyed in the flue gas stream, along with fly ash from the boiler. The carbon and fly ash are then removed by a particulate capture device such as an Electrostatic Precipitator (ESP) or baghouse.

### SUMMARY OF THE INVENTION

Various embodiments of the invention are directed to mercury removal methods including the steps of injecting an alkaline agent into a flue gas stream, and injecting a sorbent comprising an adsorptive material having a volumetric iodine number of greater than 300 mg/cc and an oxidizing agent into the flue gas stream. In some embodiments, the alkaline agent may be calcium carbonate, calcium oxide, calcium hydroxide; magnesium carbonate, magnesium hydroxide, magnesium oxide, sodium carbonate, sodium bicarbonate, trisodium hydrogendicarbonate dihydrate, and combinations thereof. In certain embodiments, the alkaline agent has a surface area of greater than 100 m²/g. In some embodiments, the alkaline agent may be injected upstream of the sorbent. In other embodiments, the alkaline agent may be injected downstream of the sorbent, and in still other embodiments, the alkaline agent injection may be co-located with that of the sorbent. In particular embodiments, the alkaline agent and the sorbent may be co-injected as a blend.

In various embodiments, the adsorptive material may be activated carbon, reactivated carbon, graphite, graphene carbon black, zeolite, silica, silica gel, clay, and combinations thereof. In certain embodiments, the adsorptive material may have a volumetric iodine number of about 350 mg/cc to about 800 mg/cc determined as the product of the gravimetric iodine number determined using standard test method ASTM D-4607 and the apparent density of the activated carbon as determined using standard test method ASTM D-2854, and in some embodiments, the adsorptive material may have a gravimetric iodine number of about 500 mg/g to about 1500 mg/g determined using standard test method ASTM D-4607.

The oxidizing agent of various embodiments may be chlorine, bromine, iodine, hydrogen bromide, ammonium bromide, ammonium chloride, calcium hypochlorite, calcium hypobromite, calcium hypoiodite, calcium chloride, calcium bromide, calcium iodide, magnesium chloride, magnesium bromide, magnesium iodide, sodium chloride, sodium bromide, sodium iodide, potassium tri-chloride, potassium tri-bromide, potassium tri-iodide, and combinations thereof. In some embodiments, the sorbent may be an impregnated adsorbent, and in other embodiments, the sorbent may be an admixture. In particular embodiments, the oxidizing agent may make up about 5 wt. % to about 50 wt. % of the sorbent.

In some embodiments, the sorbent further may include a nitrogen source, and in various embodiments, the nitrogen source may be ammonium containing compounds, ammonia containing compounds, amines containing compounds, amides containing compounds, imines containing compounds, quaternary ammonium containing compounds, and combinations thereof. In such embodiments, the nitrogen source may include about 5 wt. % to about 50 wt. % of the sorbent.

The sorbent of various embodiments may have a mean particle diameter of about 1 μm to about 30 μm. In some embodiments, injecting the alkaline agent may be carried out at a feed rate of about 500 lb/hr to about 6000 lb/hr. In some embodiments, injecting the sorbent may be carried out at a feed rate of about 5 lbs/hr to about 10 lbs/hr.

### DESCRIPTION OF DRAWINGS

In the following detailed description, reference is made to the accompanying drawings, which form a part hereof. In the drawings, similar symbols typically identify similar components unless context dictates otherwise. The illustrative embodiments described in the detailed description, drawings, and claims are not meant to be limiting. Other embodiments may be utilized and other changes may be made without departing from the spirit or scope of the subject matter presented herein. It will be readily understood that the aspects of the present disclosure, as generally described herein and illustrated in the Figures, can be arranged, substituted, combined, separated, and designed in a wide variety of different configurations, all of which are explicitly contemplated herein.

FIG. 1 is a graph showing mercury capture exhibited by various sorbents with and without upstream trona injection.

FIG. 2 is a plot of the percent mercury removal versus feed rate for 3 different brominated carbons at a site injecting trona.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention, which will be limited only by the appended claims. Unless defined otherwise, all technical and scientific terms used herein have the meaning commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entireties. Nothing herein is to be construed as an admission that the invention is not entitled to antedate such disclosure by virtue of prior invention.

It must also be noted that as used herein and in the appended claims, the singular forms “a,” “an,” and “the” include plural references unless the context clearly dictates otherwise. Thus, for example, reference to “a combustion chamber” is a reference to “one or more combustion chambers” and equivalents thereof known to those skilled in the art, and so forth.

As used herein, the term “about” means plus or minus 10% of the numerical value of the number with which it is being used. Therefore, about 50% means in the range of 45%-55%.

Embodiments of the invention are directed to mercury sorbents having enhanced mercury removal capabilities in flue gas streams. Such mercury sorbents may include a mercury adsorptive material having an iodine number of greater than 300 mg/g, and in other embodiments, the mercury adsorptive material may have an iodine number from about 500 mg/g to about 1500 mg/g. In some embodiments, these mercury sorbents may include one or more additives that may further enhance the effectiveness of the mercury adsorptive material. For example, in certain embodiments, the additives may include a source of bromide, a source of ammonia, or combinations thereof. Embodiments encompass sorbents that include an admixture of adsorptive material and additives, adsorptive materials impregnated with additives, and combinations thereof. In particular embodiments, the additives may be impregnated onto the adsorptive material.

The mercury adsorptive material of the sorbent composition of various embodiments may include any material having an affinity for mercury. For example, in some embodiments, the mercury adsorptive material may be a porous sorbent having an affinity for mercury including, but not limited to, activated carbon, reactivated carbon, graphite, graphene, zeolite, silica, silica gel, clay, and combinations thereof. In particular embodiments, the mercury adsorptive material may be activated carbon. The mercury adsorptive material may have any mean particle diameter (MPD). For example, in some embodiments, the MPD of the mercury adsorptive material may be from about 0.1 μm to about 100 μm, and in other embodiments, the MPD may be about 1 μm to about 30 μm. In still other embodiments, the MPD of the mercury adsorptive material may be less than about 15 μm, and in some particular embodiments, the MPD may be about 2 μm to about 10 μm, about 4 μm to about 8 μm, or about 5 μm or about 6 μm. In certain embodiments, the mercury adsorptive materials may have an MPD of less than about 12 μm, or in some embodiments, less than 7 μm, which may provide increased selectivity for mercury oxidation.

In certain embodiments, the mercury adsorbent may have high activity as determined by having an iodine number of greater than 300 mg/g or greater than 500 mg/g. Iodine number is used to characterize the performance of adsorptive materials based on the adsorption of iodine from solution. This provides an indication of the pore volume of the adsorbent material. More specifically, iodine number is defined as the milligrams of iodine adsorbed by one gram of carbon when the iodine concentration in the residual filtrate is 0.02 normal. Greater amounts of adsorbed iodine indicate that the activated carbon has a higher surface area for adsorption and a higher degree of activation activity level. Thus, a higher “iodine number” indicates higher activity. As used herein, the term “iodine number” can refer to either a gravimetric iodine number or a volumetric iodine number. Gravimetric iodine number can be determined using standard test method, ASTM D-4607, which is hereby incorporated by reference in its entirety, or an equivalent thereof. Volumetric iodine number is a product of the gravimetric iodine number (mg of iodine adsorbed/gram of carbon) and the apparent density of the activated carbon (grams of carbon/cc of carbon). Apparent density can be determined using ASTM D-2854, which is hereby incorporated by reference in its entirety, or an equivalent thereof. In other embodiments, granular or powdered carbon or any other form of carbon where the ASTM apparent density test cannot properly be applied, the apparent density can be determined using mercury porosimetry test ASTM 4284-12 to determine the void volume via mercury intrusion volume at 1 pound per square inch actual pressure. This intrusion volume defines the void volume of the carbon sample to allow calculation of the carbon particle density, and the apparent density is then calculated by correcting this particle density for the void fraction in a densely packed container of the carbon sample. The void fraction is 40% for a typical 3 fold range in particle size for the sample. Thus, Calculated Apparent Density (g·Carbon/cc·Carbon container)=Particle Density (g·carbon/cc·carbon particle volume)*(100%−40% voids)/100%. The result is a volume based activity with the units of mg of iodine adsorbed per cc of carbon.

Adsorbent materials typically used for mercury adsorption have an iodine number, based on the gravimetric iodine number, of about 300 mg/g to about 400 mg/g, which is thought to provide mercury adsorption characteristics equivalent to adsorptive materials having higher iodine numbers. Various embodiments of the invention are directed to mercury sorbents that include adsorbent materials having gravimetric iodine numbers greater than 400 mg/g, greater than 500 mg/g, greater than 600 mg/g, greater than 700 mg/g, greater than 800 mg/g, greater than 900 mg/g, and so on or any gravimetric iodine number therebetween. In other embodiments, the adsorptive material may have an iodine number of from about 500 mg/g to about 1500 mg/g, about 700 mg/g to about 1200 mg/g, or about 800 mg/g to about 1100 mg/g, or any gravimetric iodine number between, or range encompassed by, these exemplary ranges. In further embodiments, mercury adsorbents exhibiting an iodine number within these exemplary ranges may be activated carbon or carbonaceous char.

As determined using volumetric iodine number methods, adsorbent materials for mercury adsorption may have a volumetric iodine number from about 350 mg/cc to about 800 mg/cc. In embodiments of the invention described herein, the volumetric iodine number may be greater than 400 mg/cc, greater than 500 mg/cc, greater than 600 mg/cc, greater than 700 mg/cc, and so on or any volumetric iodine number therebetween. In other embodiments, the adsorptive material may have a volumetric iodine number of from about 350 mg/cc to about 650 mg/cc, about 400 mg/cc to about 600 mg/cc, about 500 mg/cc to about 600 mg/cc, about 500 mg/cc to about 700 mg/cc, or any volumetric iodine number between these ranges. In further embodiments, mercury adsorbents exhibiting an iodine number within these exemplary ranges may be activated carbon or carbonaceous char. In certain embodiments, these activated carbons or carbonaceous chars exhibiting a volumetric iodine number of 400 mg/cc or greater may be combined with activated carbons and carbonaceous chars exhibiting a volumetric iodine number that is less than 400 mg/cc.

Without wishing to be bound by theory, adsorbent materials having an iodine number within these exemplary ranges may provide improved adsorption over adsorbent materials having a gravimetric iodine number within the commonly used range of about 300 mg/g to about 400 mg/g. For example, in certain embodiments, about one half as much activated carbon having a gravimetric iodine number between about 700 mg/g to about 1200 mg/g or a volumetric iodine number of about 350 mg/cc to about 800 mg/cc may be necessary to adsorb the amount of mercury adsorbed by conventional activated carbon. Thus, certain embodiments are directed to methods in which about 5 lbs/hr to about 10 lbs/hr of activated carbon having an iodine number of from about 700 mg/g to about 1200 mg/g or a volumetric iodine number of about 350 mg/cc to about 800 mg/cc can adsorb an equivalent amount of mercury as about 15 lbs/hr of an activated carbon having an gravimetric iodine number of about 500 mg/g (see, Example 1).

In still other embodiments, any of the adsorptive materials described above may be treated with one or more oxidizing agents to enhance mercury adsorption. For example, in some embodiments, the oxidizing agent may be a halogen salt, including inorganic halogen salts, which for bromine may include bromides, bromates, and hypobromites; for iodine may include iodides, iodates, and hypoiodites; and for chlorine may include chlorides, chlorates, and hypochlorites. In certain embodiments, the inorganic halogen salt may be an alkali metal or an alkaline earth element containing halogen salt, where the inorganic halogen salt is associated with an alkali metal such as lithium, sodium, and potassium or an alkaline earth metal such as magnesium, or calcium counterion. Non-limiting examples of inorganic halogen salts, including alkali metal and alkali earth metal counterions include calcium hypochlorite, calcium hypobromite, calcium hypoiodite, calcium chloride, calcium bromide, calcium iodide, magnesium chloride, magnesium bromide, magnesium iodide, sodium chloride, sodium bromide, sodium iodide, potassium tri-chloride, potassium tri-bromide, potassium tri-iodide, and the like. The oxidizing agents may be included in the composition at any concentration, and in some embodiments, no oxidizing agent may be included in the compositions embodied by the invention. In embodiments in which oxidizing agents are included, the amount of oxidizing agent may be from about 5 wt. % or greater, about 10 wt. % or greater, about 15 wt. % or greater, about 20 wt. % or greater, about 25 wt. % or greater, about 30 wt. % or greater, about 40 wt. % or greater of the total sorbent, or about 5 wt. % to about 50 wt. %, about 10 wt. % to about 40 wt. %, about 20 wt. % to about 30 wt. % of the total sorbent, or any amount therebetween.

In further embodiments, any of the adsorptive materials described above may be treated with one or more nitrogen sources. The nitrogen source of such agents may be any nitrogen source known in the art and can include, for example, ammonium, ammonia, amines, amides, imines, quaternary ammonium, and the like. In certain embodiments, the agent may be, for example, chlorine, bromine, iodine, hydrogen bromide, ammonium halide, such as ammonium iodide, ammonium bromide, or ammonium chloride, an amine halide, a quaternary ammonium halide, or an organo-halide and combinations thereof. In some embodiments, the nitrogen containing agent may be ammonium halide, amine halide, or quaternary ammonium halide, and in certain embodiments, the agent may be an ammonium halide such as ammonium bromide. In various embodiments, the nitrogen containing agent may be about 5 wt. % or greater, about 10 wt. % or greater, about 15 wt. % or greater, about 20 wt. % or greater, about 25 wt. % or greater, about 30 wt. % or greater, about 40 wt. % or greater of the total sorbent, or about 5 wt. % to about 50 wt. %, about 10 wt. % to about 40 wt. %, about 20 wt. % to about 30 wt. % of the total sorbent, or any amount therebetween.

The ammonium halide, amine halide, or quaternary ammonium halide may be absent in some embodiments. In other embodiments, the ammonium halide, amine halide, or quaternary ammonium halide may be the only additive included in the sorbent composition, and in still other embodiments, the ammonium halide, amine halide, or quaternary ammonium halide may be combined with other agents such as, for example, halide salts, halide metal salts, alkaline agents, and the like to prepare a composition or sorbent encompassed by the invention. In particular embodiments, the sorbent may include at least one of a halogen salt such as sodium bromide (NaBr), potassium bromide (KBr), or ammonium bromide (NH₄Br).

In other embodiments, the mercury adsorptive material may be treated to enhance the hydrophobicity of the adsorptive materials with, for example, one or more hydrophobicity enhancement agents that impede the adsorption and transport of water or other treatments of the sorbent that achieve similar results. Embodiments are not limited to the type of treated mercury adsorptive material or the means by which the mercury adsorptive material has been treated with a hydrophobicity enhancement agent. For example, in some embodiments, the mercury adsorptive material may be treated with an amount of one or more elemental halogens that can form a permanent bond with the surface. The elemental halogen may be any halogen such as fluorine (F), chlorine (Cl), or bromine (Br), and in certain embodiments, the elemental halogen may be fluorine (F). In other embodiments, the mercury adsorptive material may be treated with a hydrophobicity enhancement agent such as a fluorine salt, organo-fluorine compound, or fluorinated polymer, such as, TEFLON®.

The term “treated,” as used above in connection with the adsorptive material and various additives, is meant to encompass adsorptive materials that are impregnated with an oxidizing agent or an oxidizing agent and a nitrogen source, or adsorptive materials that are admixed with an oxidizing agent or an oxidizing agent and a nitrogen source. For example, in particular embodiments, the adsorptive material may be an impregnated adsorptive material having an oxidizing agent such as a bromide containing compound, a nitrogen source such as an ammonium containing compound, or a combination thereof disposed on a surface of the sorbent. In some embodiments, the additive impregnated sorbent may form interspersed thinly layered patches on exposed surfaces of the sorbent material, and in certain embodiments, the patches may extend into the pores of the sorbent. In other embodiments, the adsorptive material may be admixed with an oxidizing agent such as a bromide containing compound, a nitrogen source such as an ammonium containing compound, or a combination thereof. In further embodiments, an impregnated additive having one of an oxidizing agent or a nitrogen source admixed the other additive. For example, in some embodiments, an adsorptive material impregnated with a bromide containing compound can be admixed with an ammonium containing additive.

The adsorbent material may be combined with an oxidizing agent, nitrogen containing compound, hydrophobicity agent, acid gas suppression agent, or other mercury removal agent (collectively, “additives”) in any way known in the art. For example, in some embodiments, the one or more additive may be introduced onto the surface of the adsorbent material by impregnation, in which the adsorbent material is immersed in a liquid mixture of additives or the liquid mixture of additives is sprayed or otherwise applied to the adsorbent material. Such impregnation processes result in an adsorbent material in which the additives are dispersed on the surface of the adsorbent material.

In various other embodiments, treatment of the adsorbent material may be combined with one or more additives as a dry admixture, in which particles of adsorbent are separate and apart from particles of additive having substantially the same size. For example, in some embodiments, an admixture may be prepared by co-milling activated carbon with one or more additive to a mean particle diameter (MPD) of less than or equal to about 12 μm, less than or equal to about 10 μm, or less than about 7 μm. Without wishing to be bound by theory, reducing the mean particle diameter of the sorbent and additives by co-milling allows for a close localization of the sorbent and the additives, but the additives are not contained within the sorbent pore structure. These dry admixtures have been found to be surprisingly effective in facilitating rapid and selective mercury adsorption. This effect has been shown to be particularly effective when all components of the sorbent are combined and co-milled or otherwise sized to a mean particle diameter of less than or equal to about 12 μm. Co-milling may be carried out by any means. For example, in various embodiments, the co-milling may be carried out using bowl mills, roller mills, ball mills, jet mills or other mills or any grinding device known to those skilled in the art for reducing the particle size of dry solids.

Although not wishing to be bound by theory, the small MPD may improve the selectivity of mercury adsorption as the halide effectively oxidizes the mercury. As such, dry admixtures of adsorbent materials and additives may allow for a higher percentage of active halide and alkaline agents to be included in the injected sorbent. Mercury adsorbents that are impregnated with an additive by treating with an aqueous solution of the additive, for example, commercial brominated carbon sorbents, especially those impregnated with elemental bromine, can only retain a small percentage of the additive on the surface of the adsorbent, and impregnation tends to clog the pores of porous mercury adsorbents, reducing the surface area available for mercury adsorption. In contrast, the percentage of additive in a dry mixture may be greater than about 10 wt. %, greater than about 15 wt. %, greater than about 20 wt. %, or greater than about 30 wt. %, and up to about 50 wt. %, up to about 60 wt. %, or up to about 70 wt. % without exhibiting a reduction in mercury adsorption efficiency.

Adsorptive materials and additives may be combined by any method. For example, in some embodiments, an adsorptive material and one or more additives may be combined by blending or mixing the materials into a single mercury sorbent that can then be injected into a flue gas stream. In other embodiments, combining may occur during use such that the adsorptive material and the one or more additives are held in different reservoirs and injected simultaneously into a flue gas stream.

Numerous alkaline agents are known in the art and currently used to remove sulfur oxide species from flue gas, and any such alkaline agent may be used in the invention. For example, in various embodiments, the alkaline additive may be alkali oxides, alkaline earth oxides, hydroxides, carbonates, bicarbonates, phosphates, silicates, aluminates, and combinations thereof. In certain embodiments, the alkaline agent may be calcium carbonate (CaCO₃; limestone), calcium oxide (CaO; lime), calcium hydroxide (Ca(OH)₂; slaked lime); magnesium carbonate (MgCO₃; dolomite), magnesium hydroxide (Mg(OH)₂), magnesium oxide (MgO), sodium carbonate (Na2CO₃), sodium bicarbonate (NaHCO₃; SBC), trisodium hydrogendicarbonate dihydrate (Na₃H(CO₃)₂.2H₂O; trona), and combinations thereof. In particular embodiments, such alkaline agents may have a relatively high surface area such as, for example, above 100 m²/g for neat materials. High surface area materials may provide improved kinetics and capabilities for acid gas or SOx mitigation while complementing halogen compounds and other added oxidants to provide oxidation of elemental mercury.

In particular embodiments, the methods described above may be used for adsorption of mercury from flue gas streams containing acid gases such as sulfur oxide species, i.e., SOx, such as, SO₃ and/or SO₂, and other acid gases. In general, mercury adsorptive materials such as activated carbon adsorb mercury with less efficiency in flue gas streams having high concentrations of sulfur oxide species. In particular, sulfur trioxide, SO₃, is strongly adsorbed by activated carbon. Sulfur dioxide, SO₂, although less strongly adsorbed, can be oxidized by oxygen to form sulfur trioxide in the flue gas in the presence of catalytic sites on the adsorbent's surface. The overall effect of adsorption of these sulfur oxides precludes or strongly interferes with the adsorption of mercury from the flue gas.

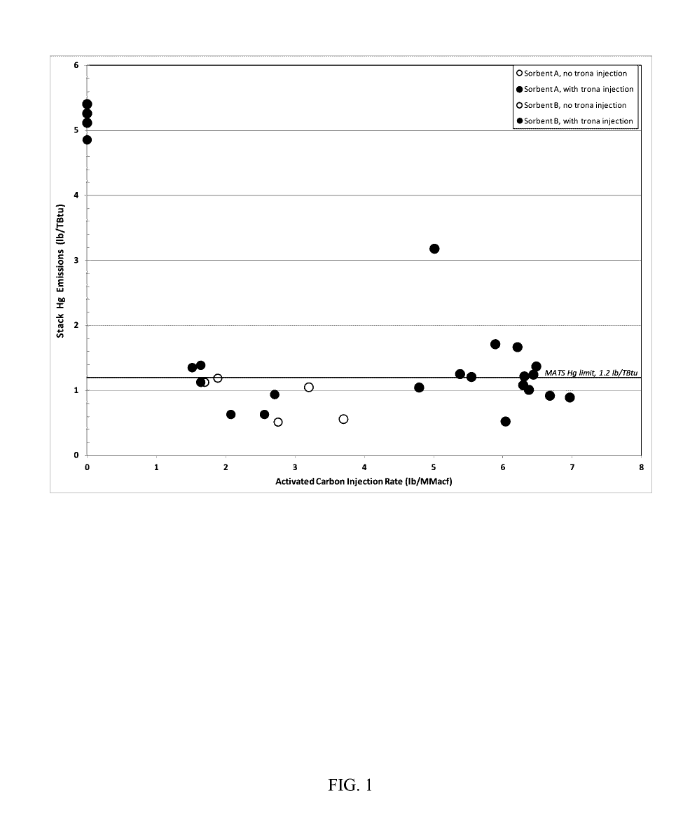

When alkaline agents such as trona are used in quantities sufficient for SO₂ control, the trona removes HBr and HCl from the flue gas, and thereby inhibits mercury oxidation. Injecting an adsorptive material that has been treated with an oxidizing agent and a nitrogen containing compound that readily decompose to release HBr upon injection into the flue gas can allow HBr concentrations to remain at levels sufficient to facilitate mercury capture in the immediate proximity of the adsorptive material. In particular, adsorptive materials treated with bromide salts such as ammonium bromide provide a large increase in mercury removal performance in trona, or SBC, treated streams as compared to other commonly used bromide salts like sodium bromide and potassium bromide. In testing on a 140 MW PRB-fired unit with trona injection for SO₂ control and an ESP, a product formulated with ammonium bromide was observed to require half as much sorbent or even less for mercury control as compared to competitive carbons containing sodium bromide (Sorbent B in FIG. 1). Furthermore, the mercury removal performance of the product appeared to be insensitive to changes in trona feed rates in the range of 500-6000 lb/hr.

Additionally, sodium sorbents tend to generate low ppm levels of NO₂ that are also thought to impede mercury capture by carbon. NO₂ adsorbs on adsorptive materials such as activated carbon and may compete with mercury species for adsorption sites. The presence of NO₂ on the surface of the carbon can catalyze the oxidation of SO₂ to SO₃ which also inhibits mercury capture by carbon. Ammonia can react with (and thereby remove) the NO₂ that is produced by trona or SBC, particularly at temperatures typically encountered upstream of the air pre-heater (650-900° F.). In some embodiments, the amount of adsorbent needed to control NO₂ induced “brown plume” problems caused by sodium sorbents was reduced by two thirds when the adsorbent injection was moved from a point downstream of the air pre-heater (cold side) at roughly 300° F. to a point upstream of the air pre-heater (hot side) at around 700° F. Without wishing to be bound by theory, ammonia may be released on the hot side, which consumed a large portion of the NO₂, allowing the adsorbent to adsorb mercury on the cold side without inhibition by NO₂.

### EXAMPLES

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples.

### Example 1

FIG. 1 shows results at a PRB-fired unit with trona injection for SO₂ control and an ESP. Here, the mercury removal performance of a product formulated with 30 wt. % ammonium bromide (Sorbent B) was observed to be insensitive to the co-injection of trona as compared to a carbon containing only 6% ammonium bromide (Sorbent A) which required large increases in injection rates to reach the mercury compliance goal when trona was co-injected.

These data show that activated carbon impregnated with a sufficiently high ammonium bromide level (>6%) provided excellent mercury adsorption at relatively low injection rates, despite the use of trona injection for SO₂ control.

### Example 2

At the same test site, this strategy of using a carbon formulated with ammonium bromide was shown to be particularly advantageous when compared to the alternate strategy of using a non-brominated carbon and CaBr₂ addition to the coal. The latter strategy is normally very effective at controlling mercury on PRB-fired units, including this one. However, when trona DSI was turned on, the mercury removal performance matched that obtained with non-brominated carbon alone because the trona was scrubbing the HBr generated by the CaBr₂. Thus, having a product that can release HBr spontaneously in the direct vicinity of the activated carbon as it is injected provides for effective mercury oxidation and subsequent capture by the carbon, whereas the use of CaBr₂ in addition to the coal did not. This type of product is also expected to be advantageous in flue gas streams in which calcium sorbents are used for SO₂ control, since such materials will similarly remove HBr.

### Example 3

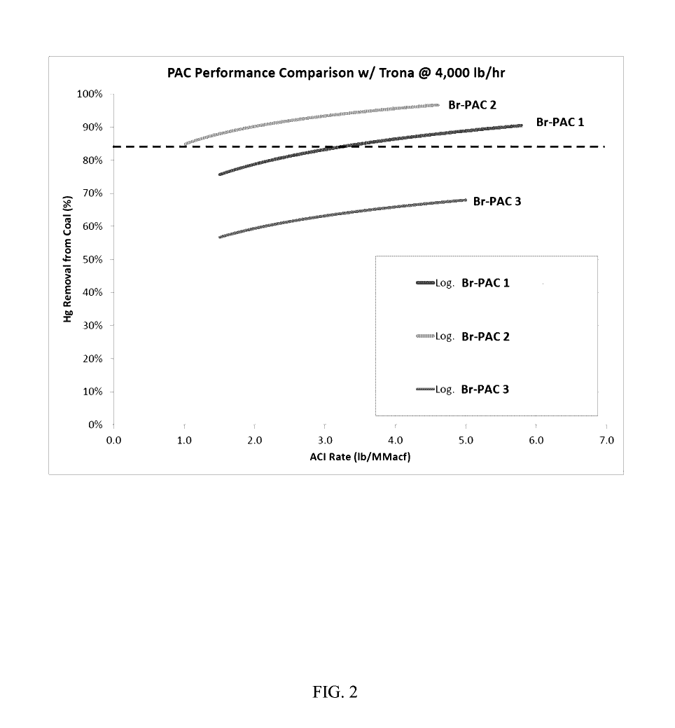

The combination of activated carbon with relatively high volumetric iodine values of 500 mg/cc or more and ammonium bromide was highly effective at mercury removal at sites injecting trona DSI. FIG. 2 shows a plot of the percent mercury removal versus feed rate for 3 different brominated carbons at a site injecting trona at 4,000 lb/hr for SO₂ control.

Br-PAC 3 is low volumetric iodine PAC formulated with sodium bromide and was found to be unable to meet the treatment objective denoted by the dashed line. Br-PAC 1 is high volumetric iodine PAC formulated with ammonium bromide and far outperformed Br-PAC 3. Br-PAC 2 is high volumetric iodine PAC formulated with twice as much ammonium bromide as Br-PAC 1 and performed even better still.

1. A method for mercury removal comprising:
injecting an alkaline agent into a flue gas stream; and
injecting a sorbent comprising an adsorptive material having a volumetric iodine number of greater than 300 mg/cc and an oxidizing agent into the flue gas stream.

2. The method of claim 1, wherein the alkaline agent is selected from the group consisting of calcium carbonate, calcium oxide, calcium hydroxide; magnesium carbonate, magnesium hydroxide, magnesium oxide, sodium carbonate, sodium bicarbonate, trisodium hydrogendicarbonate dihydrate, and combinations thereof.

3. The method of claim 1, wherein the alkaline agent has a surface area of greater than 100 m²/g.

4. The method of claim 1, wherein the alkaline agent is injected upstream of the sorbent.

5. The method of claim 1, wherein the alkaline agent is injected downstream of the sorbent.

6. The method of claim 1, wherein the alkaline agent injection is co-located with that of the sorbent.

7. The method of claim 1, wherein the alkaline agent and the sorbent are co-injected as a blend.

8. The method of claim 1, wherein the adsorptive material is selected from the group consisting of activated carbon, reactivated carbon, graphite, graphene carbon black, zeolite, silica, silica gel, clay, and combinations thereof.

9. The method of claim 1, wherein the adsorptive material has a volumetric iodine number of about 350 mg/cc to about 800 mg/cc determined as the product of the gravimetric iodine number determined using standard test method ASTM D-4607 and the apparent density of the activated carbon as determined using standard test method ASTM D-2854.

10. The method of claim 1, wherein the adsorptive material has a gravimetric iodine number of about 500 mg/g to about 1500 mg/g determined using standard test method ASTM D-4607.

11. The method of claim 1, wherein the oxidizing agent is selected from the group consisting of chlorine, bromine, iodine, hydrogen bromide, ammonium bromide, ammonium chloride, calcium hypochlorite, calcium hypobromite, calcium hypoiodite, calcium chloride, calcium bromide, calcium iodide, magnesium chloride, magnesium bromide, magnesium iodide, sodium chloride, sodium bromide, sodium iodide, potassium tri-chloride, potassium tri-bromide, potassium tri-iodide, and combinations thereof.

12. The method of claim 1, wherein the sorbent is an impregnated adsorbent.

13. The method of claim 1, wherein the sorbent is an admixture.

14. The method of claim 1, wherein the oxidizing agent comprises about 5 wt. % to about 50 wt. % of the sorbent.

15. The method of claim 1, wherein the sorbent further comprises a nitrogen source.

16. The method of claim 10, wherein the nitrogen source is selected from the group consisting of ammonium containing compounds, ammonia containing compounds, amines containing compounds, amides containing compounds, imines containing compounds, quaternary ammonium containing compounds, and combinations thereof.

17. The method of claim 10, wherein the nitrogen source comprises about 5 wt. % to about 50 wt. % of the sorbent.

18. The method of claim 1, wherein the sorbent has a mean particle diameter of about 1 μm to about 30 μm.

19. The method of claim 1, wherein injecting the alkaline agent is carried out at a feed rate of about 500 lb/hr to about 6000 lb/hr.

20. The method of claim 1, wherein injecting the sorbent is carried out at a feed rate of about 5 lbs/hr to about 10 lbs/hr.
